(19) United States
(12) Patent Application Publication
(10) Pub. No.: US 2012/0186944 A1
(43) Pub. Date: Jul. 26, 2012

(54) ARTICLE TRANSFER AND PLACEMENT APPARATUS WITH ACTIVE PUCK

(75) Inventor: John A. McCabe, Sheboygan Falls, WI (US)

(73) Assignee: CURT G. JOA, INC., Sheboygan Falls, WI (US)

(21) Appl. No.: 13/188,985

(22) Filed: Jul. 22, 2011

Related U.S. Application Data
(63) Continuation-in-part of application No. 12/806,283, filed on Aug. 9, 2010, now Pat. No. 7,987,964.
Application No. 12/806,283 is a continuation of application No. 11/357,546, filed on Feb. 17, 2006, now Pat. No. 7,770,712.
Application No. 11/357,546 is a continuation of application No. 13/178,104, filed on Jul. 7, 2011.
Application No. 13/178,104 is a division of application No. 12/070,879, filed on Feb. 21, 2008, now Pat. No. 7,975,584.
(60) Provisional application No. 60/902,477, filed on Feb. 21, 2007.

(51) Int. Cl. B65G 47/86

(52) U.S. Cl. 198/470.1

(57) ABSTRACT

An apparatus for transferring articles such as absorbent cores or disposable diaper chassis components from a rotary mechanism, such as a pad turner, to a linear mechanism, such as a conveyor, for further processing. A puck on the apparatus is capable of stretching and rotating the article during this transfer procedure. The puck includes a pair of end segments each of which is arranged to move from a first position where each end segment is at a first distance and a first angle relative to the puck and a second position where each end segment is at a second distance and a second angle relative to the puck during the transfer process.

### RELATED APPLICATIONS

This application is a continuation-in-part of co-pending U.S. application Ser. No. 12/806,283 filed 9 Aug. 2010, which is a continuation of patent application Ser. No. 11/357,546 filed 17 Feb. 2006 (now U.S. Pat. No. 7,770,712) and is a continuation of U.S. application Ser. No. 13/178,104 filed 7 Jul. 2011, which is a divisional application of U.S. application Ser. No. 12/070,879 filed 21 Feb. 2008 (now U.S. Pat. No. 7,975,584) which claims the benefit of U.S. Provisional Patent Application Ser. No. 60/902,477, filed 21 Feb. 2007.

### BACKGROUND OF THE INVENTION

This invention related to an apparatus for transferring articles such as absorbent pads in the manufacture of disposable absorbent articles such as diapers, incontinence control garments or female sanitary pads as they advance along a production line.

In the production and manufacture of disposable products such as sanitary napkins or pants-type diapers, it frequently becomes necessary to manufacture a component of the product in one orientation, and then to rotate that component part 90° so that it is suitably oriented for use in another step in the production process. Various devices have been developed for this purpose and are known to those experienced in the industry. Examples of such apparatus are those described in U.S. Pat. Nos. 4,726,876, 4,880,102, and 5,025,910, the disclosures of which are incorporated herein by reference.

As discussed above, a typical article to be reoriented by the apparatus of this invention is an absorbent pad. Because absorbent pads are typically comprised of several webs, an absorbent core and several elastic members, there is a tendency of these assemblies to contract and become distorted during transfer operations which greatly complicates handling of the pad during further processing. Control of the pad is important.

### SUMMARY OF THE INVENTION

The apparatus of the present invention is an active puck that is capable of rotating and stretching an article between a pick-up and a lay-down point.

An active puck is disclosed that picks up an article from a first conveying means, the article traveling in a first orientation, carries, stretches and rotates the article, so the article is traveling in a second orientation, and deposits the article onto another conveying means. A cam plate comprising a guiding structure of increasing radius cooperates with a vacuum slide to urge stretching of the article is provided. A vacuum puck carries the article while the slide rotatably operates through the increasing (or decreasing) radius.

The puck includes a puck body having a first end and a second end with a first end segment at the first end and a second end segment at the second end. Each of the first and second end segments are slidably engaged with a pair of generally curved rails. As the puck in rotated, the first and second end segments slide along the rails, moving the first and second end segments relative to the puck body and tilting the first and second end segments relative to the puck body.

### BRIEF DESCRIPTION OF THE DRAWINGS

FIG. 1 is a fragmentary side elevation view, shown in diagrammatic form, of a pad transferring assembly;

FIG. 2 is a perspective fragmentary, diagrammatic view, showing related apparatus by means of phantom lines and illustrating the path of movement of pads moving in accordance with the invention;

FIG. 3 is a top view of an embodiment of an active pad turning puck of the present invention;

FIG. 4 is a top view of an embodiment of an active pad turning puck of the present invention;

FIG. 5 is a top view of an embodiment of an active pad turning puck of the present invention;

FIG. 6 is an exploded view of an active pad turning puck of the present invention;

FIG. 7 is a top view of an alternate embodiment of an active pad turning puck of the present invention;

FIG. 8 is a top view of an alternate embodiment of an active pad turning puck of the present invention;

FIG. 9 is a top view of an additional alternate embodiment of an active pad turning puck of the present invention;

FIG. 10 is a top view of an additional alternate embodiment of an active pad turning puck of the present invention.

FIG. 11 is a top view of an additional alternate embodiment of an active pad turning puck of the present invention.

FIG. 12 is a perspective view of a puck support according to the present invention.

FIG. 13 is a perspective view of an additional alternative embodiment of an active pad turning puck according to the present invention.

FIG. 14 is a side elevation view of the puck of FIG. 13.

FIG. 15 is a cross-section view taken along line 14-14 of FIG. 14.

FIG. 16 is a top plan view of the puck of FIG. 13.

FIGS. 17A, 17B and 17C are simplifies side elevation views of the puck of FIG. 13 as it rotates from a first web receiving position (FIG. 17A) to a second web placement position (FIG. 17C).

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

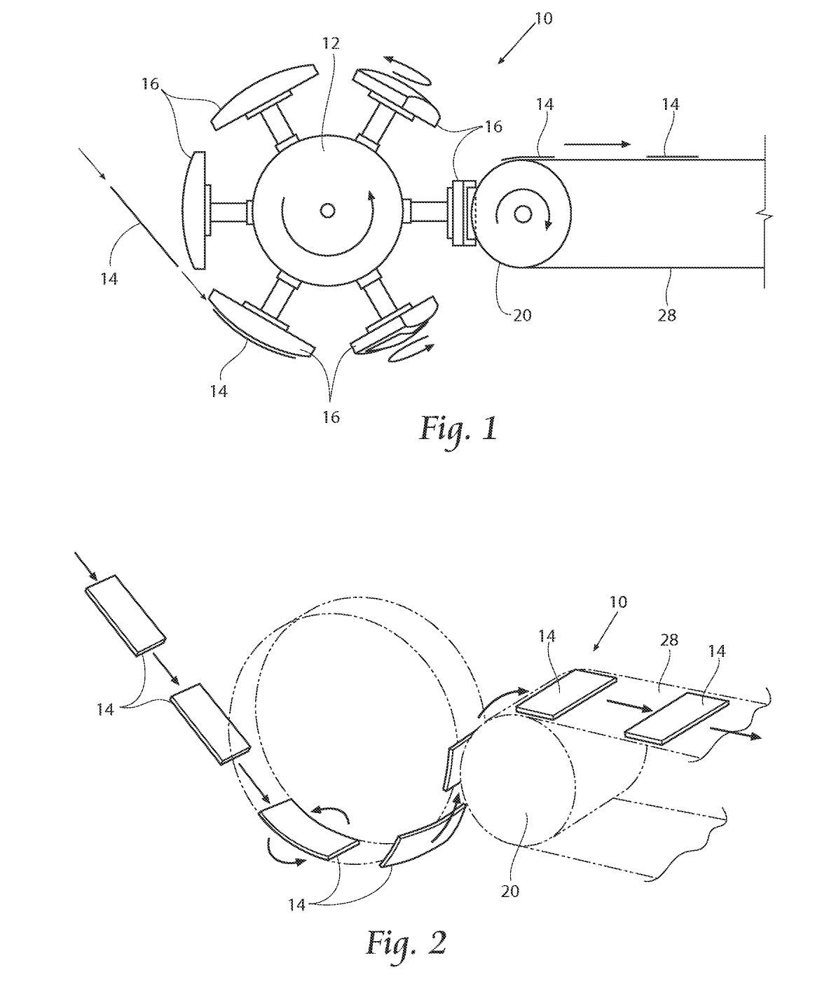

Referring more particularly to the drawings, there is seen in FIG. 1 an apparatus 10 carrying pucks, or transfer heads 16, of the present invention. The apparatus 10 is adapted to receive a series of articles 14 from an upstream conveyor or vacuum drum (not shown) onto a pad turning device 12 which includes a plurality of radially extending transfer heads 16.

The location where articles 14 are received from the upstream point onto the pucks 16 is known as the pick up point. The location where articles 14 are deposited from the pucks 16 to a downstream drum or conveyor 20 is known as the lay down point.

The pad turning device 12 may be, for example, a rotary pad turner of the type more fully described in U.S. Pat. No. 5,025,910 which is incorporated herein by reference. The articles 14, such as absorbent pads, may be any elongated articles which need to be rotated approximately 90° during the course of a manufacturing operation. In the present invention, the elongated articles are also stretched away from their center point in a direction, such as a radial direction, away from the axis of the puck 16 as will be described later.

Such pad turning devices 12 are especially needed and are suited for use in connection with the manufacture and packaging of sanitary napkins as well as absorbent pads which are used in the assembly of disposable garments such as adult incontinence garments or children's training pants.

Also seen in FIG. 1, articles 14 are successively and individually picked-up by the transfer heads 16 of the pad transfer device 12. In the illustrated embodiment, the articles 14 are picked up from a vacuum drum (not shown). Various conventional conveying and direction changing devices such as rollers may be employed in the feeding of the web and do not form a part of this invention.

After the articles 14 have been rotated 90 degrees, they are deposited at the lay down point onto drum 20. The pucks 16 of the present invention can stretch the articles 14, as will be described below, and deposit them in the stretched condition onto drum 20. A conveyor 28 or the like transport the articles 14 for further processing or to a packaging device, as required by a particular application.

Referring to FIG. 2, there is seen a diagrammatic depiction of the travel path of the web 22 and the resultant pads 14 which are formed therefrom. In this depiction the various apparatus have been eliminated but are partially illustrated by means of phantom lines.

As can be seen, the article is rotated 90° from the pick up point to the lay down point, and is also stretched during this time it spends on the puck 16. The active puck 16 of this invention is more fully described in the remaining Figures.

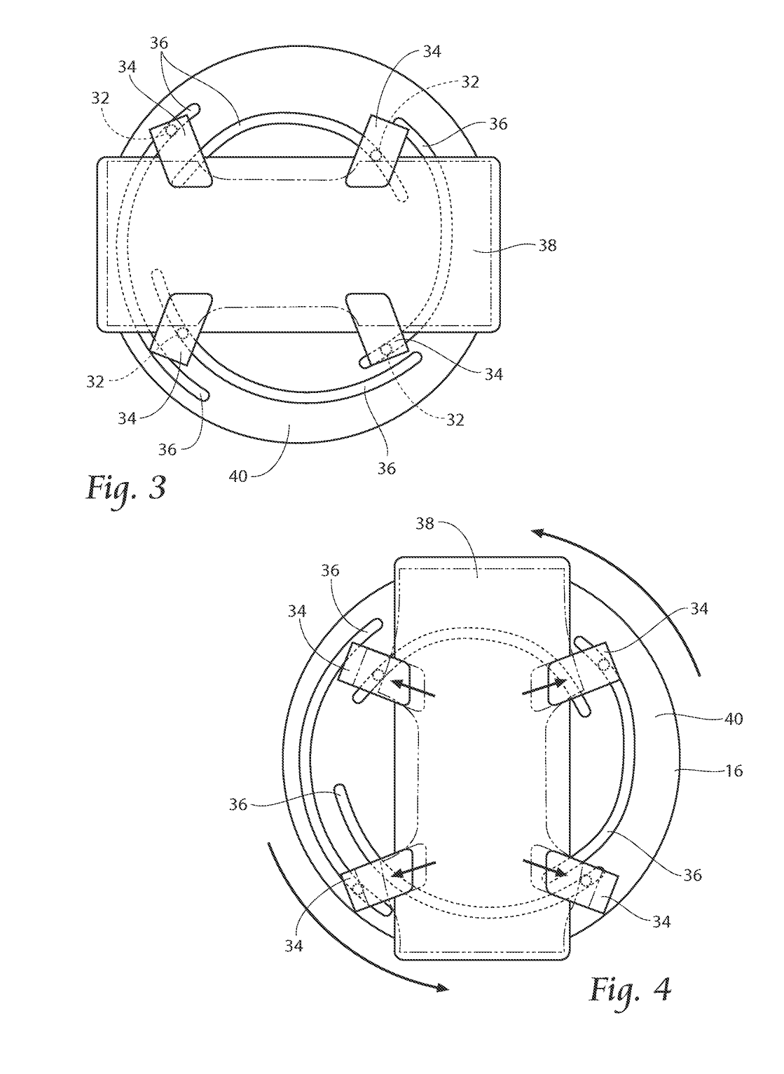

As shown in FIG. 3, a top view of an embodiment of an active pad turning puck 16 of the present invention is shown. A plurality of vacuum slides 34 are positioned about a puck assembly 38. The vacuum slides 34 are intended to engage a portion of articles 14 (not shown) by vacuum ports 42, and manipulate by stretching or otherwise the articles 14. As is well known in the art, each of the segments can be connected internally to a source of vacuum. A pattern of holes is provided on the surface of each segment through which the internal vacuum acts to draw the pads 14 towards the surface. It is clear that this technology can be applied to the transfer and placement of many different types of articles in the disposable goods industry and other industries as well.

In use, rotation of the puck assembly 38 relative to a cam plate 40 causes cam followers 32 to track through channels 36. Channels 36 are of an increasing radius from the center of the cam plate 40. Because cam followers 32 are coupled with vacuum slides 34, rotation of the puck assembly 38 relative to the cam plate 40 causes sliding of the vacuum slides inwardly and outwardly as shown in FIG. 4. The cam followers 32 are urged inwardly and outwardly due to the increasing radius of the channels 36 in a first direction of travel, and the decreasing radius of channels 36 in the second rotational direction of travel, preferably in a washing machine-like back and forth style.

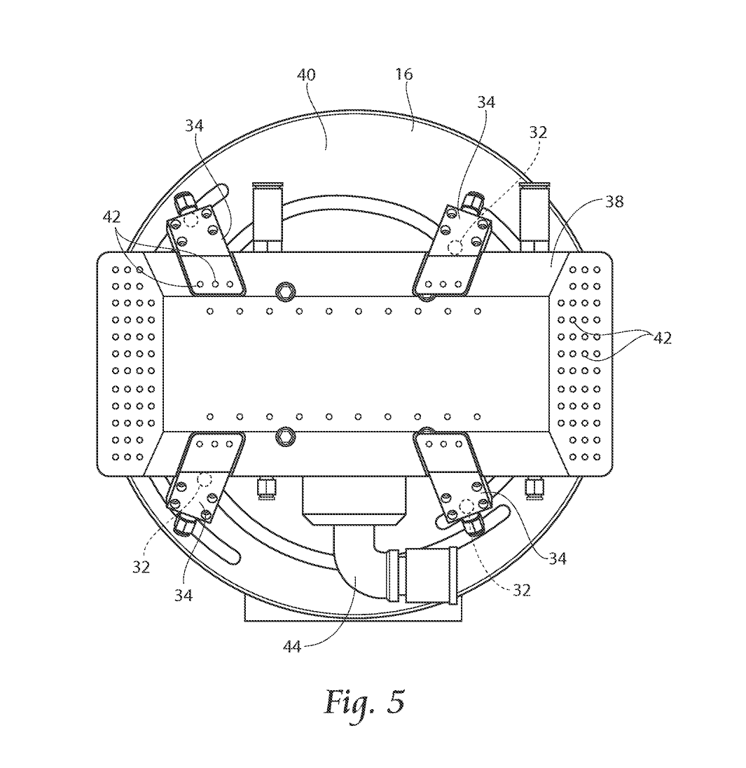

Referring now to FIG. 5, a top view the active pad turning puck 16 of the present invention is shown. In this embodiment, vacuum ports 42 are shown, and may be applied to the vacuum slides 34, the puck assembly 38, or both. The vacuum ports are coupled to a manifold 44 and ultimately a source of vacuum (not shown).

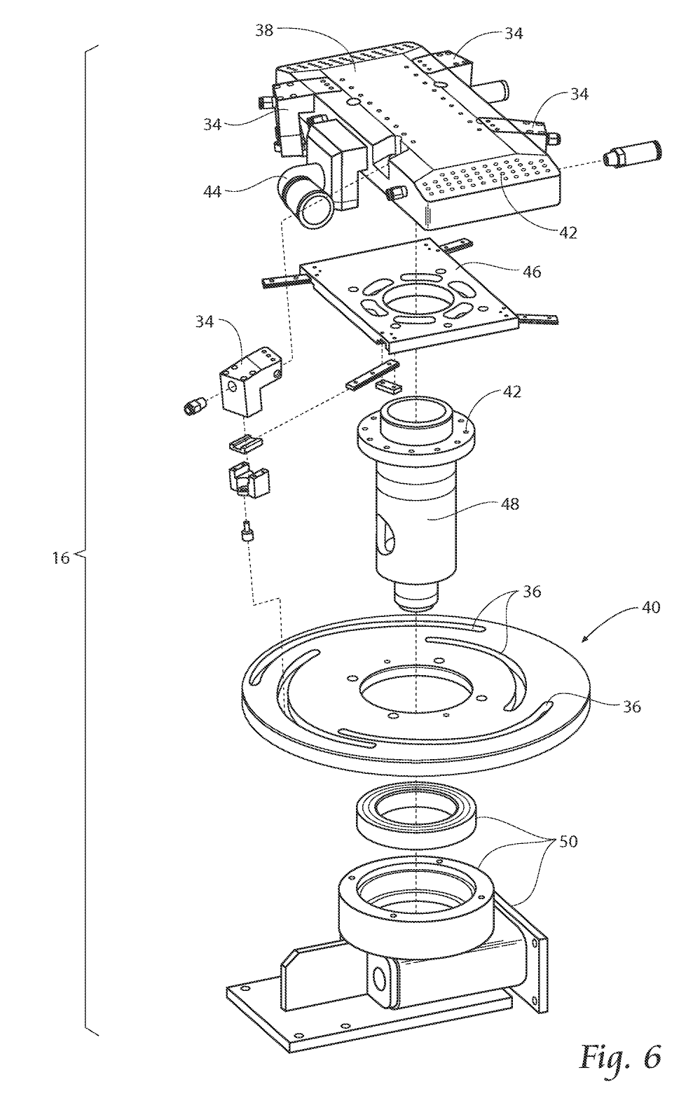

Referring now to FIG. 6, an exploded view of the active pad turning puck 16 of the present invention is shown. In this embodiment, a shaft adaptor plate 46 is shown to receive shaft 48, through a void provided proximal to the center of cam plate 40. The support subassembly 50 is provided for coupling of the puck 16 to the pad turning device 12.

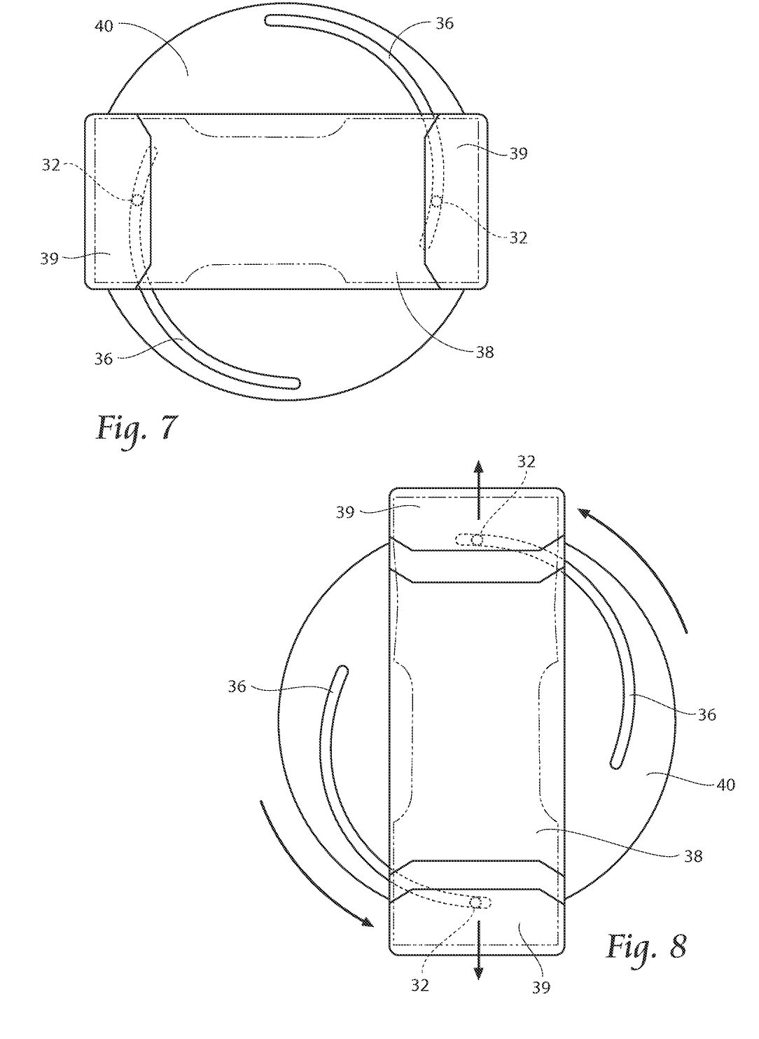

Referring now to FIG. 7, a top view of an alternate embodiment of an active pad turning puck 16 of the present invention is shown. In this embodiment, ends 39 of the puck assembly 38 are slidably enabled, as the vacuum slides 34 described previously. Rotation is again a driving force of sliding movement caused by the cam follower 32 coupled to the ends 39, as shown in FIG. 8.

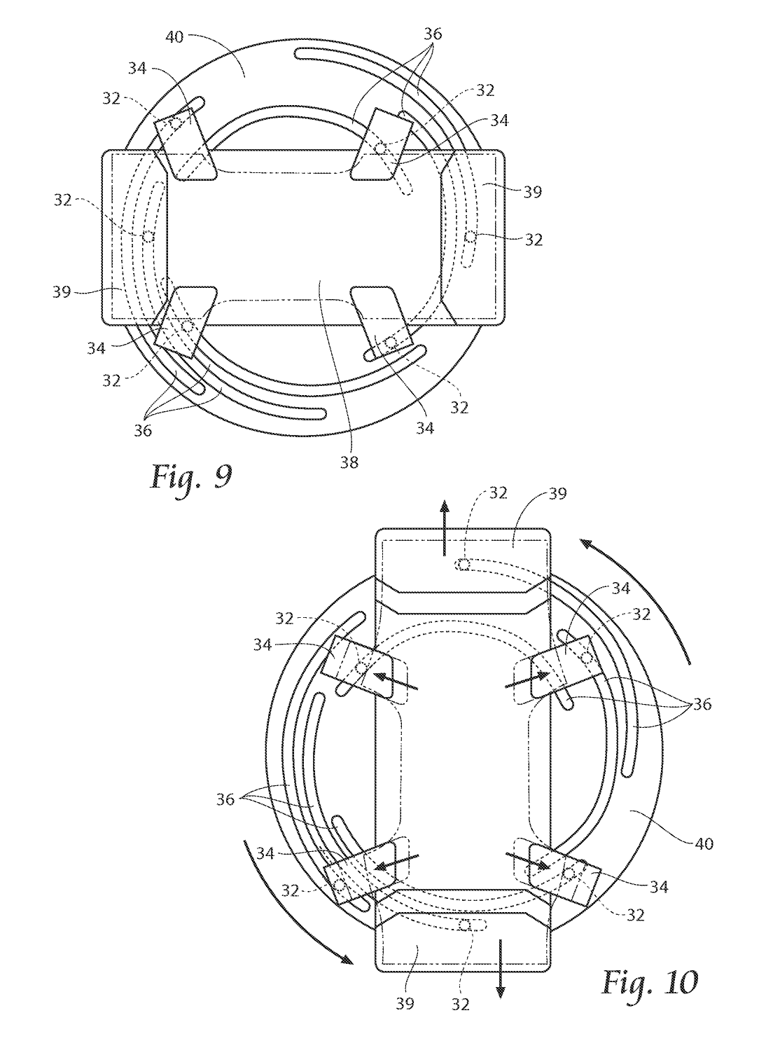

Referring now to FIGS. 9 and 10, a top view of an additional alternate embodiment of an active pad turning puck 16 of the present invention is shown. In this embodiment, a plurality of channels 36 are provided, each channel 36 receiving a cam follower 32 coupled to a slidable element, either ends 39 or slides 34. Of course, a single circuitous channel 36 could be provided for receiving multiple cam followers 32. Again, cam followers 32, upon rotation, urge the slidable elements outward and inward.

Referring now to FIG. 11, an additional alternative embodiment of a puck 16 of the present invention is shown. In this embodiment, it can be seen that a slidable elements 46 are provided at corners of the puck assembly 38. These slidable elements 46 will move somewhat radially away from the center of the puck 16, although the direction of movement can be controlled through different arrangements of the channel or channels 36.

In use, the transfer apparatus 10 rotates from the pick up point, stretches the article 14 while the article is upon a puck 16 by slidable elements, and deposits the article 14 on a conveyor 28 or the like for downstream processing. As the puck 16 rotates between the pick up and deposition points, the cam followers are urged into an increasing radius of the channel 36. Between the deposition point and the next subsequent pick up point, the puck 16 will rotate back to its initial position, and the cam followers are urged into an its decreasing radius of the channel 36, causing the slidable elements 34 or 39 to return to their initial, retracted position, ready to receive another article 14.

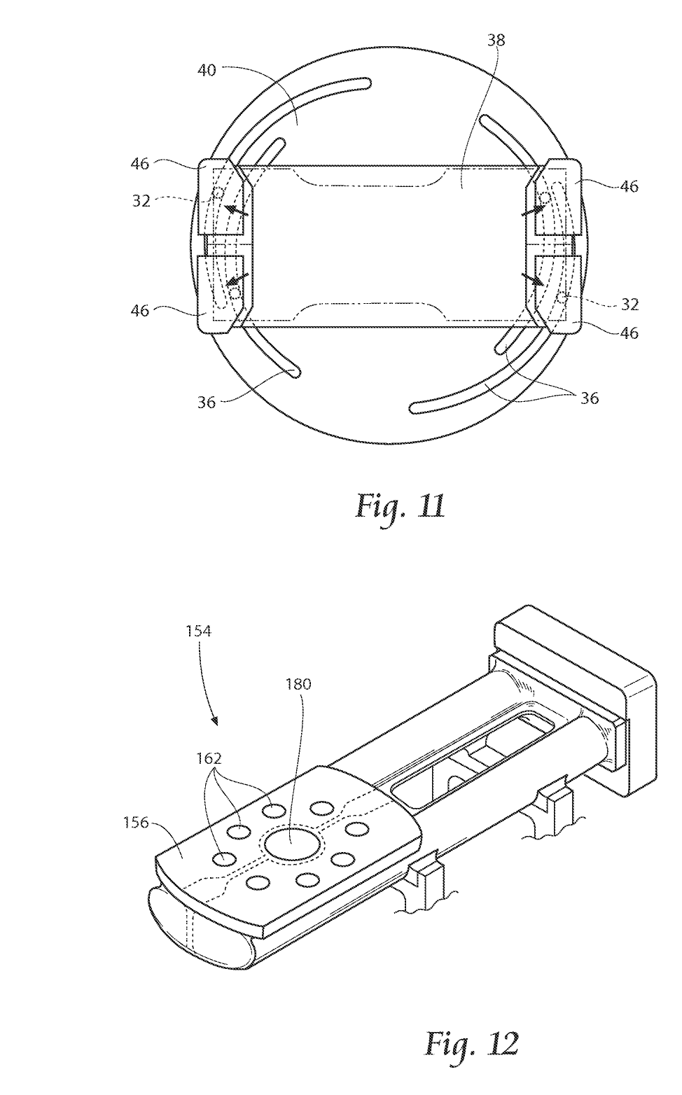

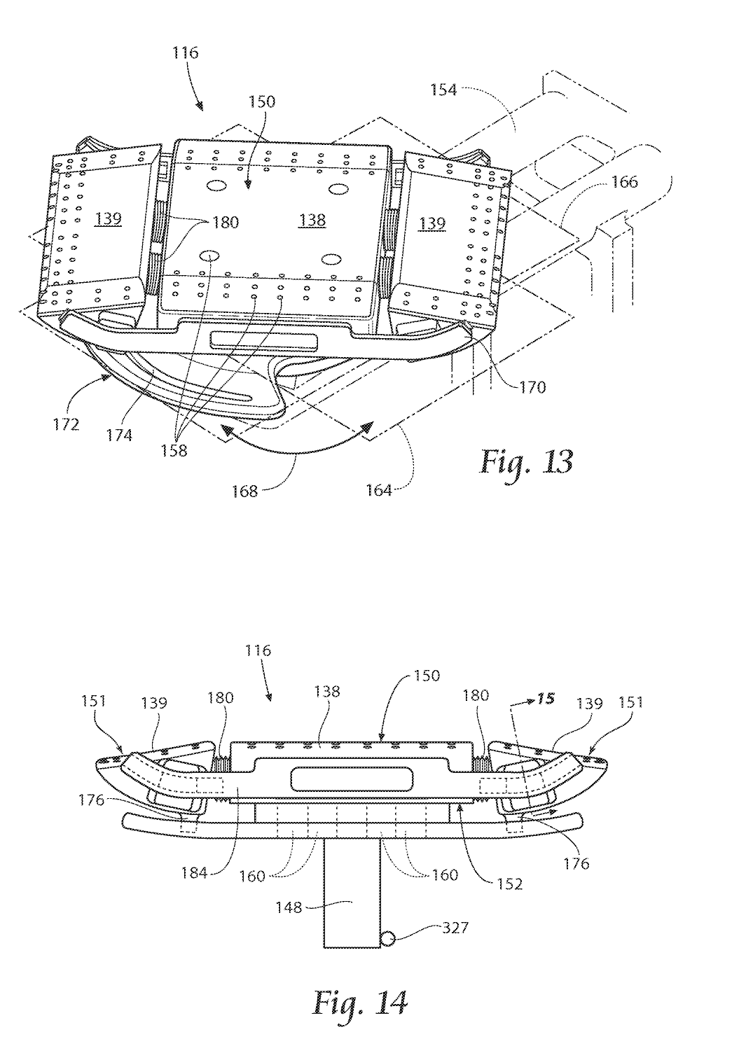

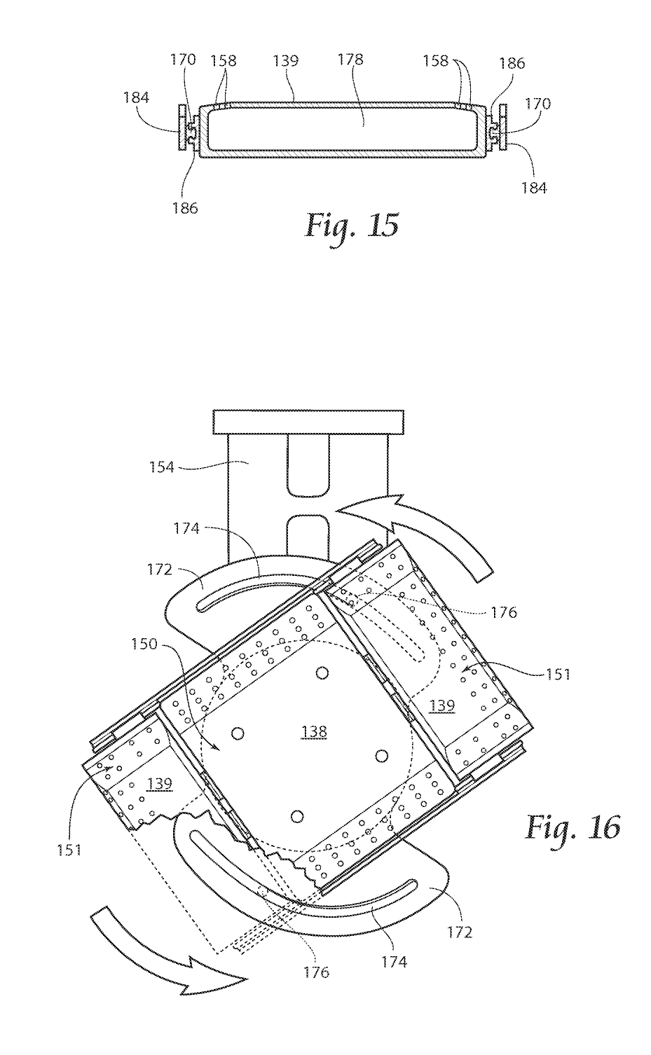

FIGS. 12, 13, 14, 15, 16, 17A, 17B and 17C show an additional embodiment of a puck according to the present invention. Referring to FIG. 13, the puck 116 has a puck body 138 having a first web surface 150, a support surface 152 preferably oppositely disposed from the web surface 150, and a bearing shaft 148 depending from the support surface 152. The bearing shaft 148 is adapted to be rotatably supported by a puck support 154 (see FIG. 12), such as being rotatably held in the bearing aperture 180 in the puck support head 156. The puck body 138 includes a vacuum chamber (not shown) within the body 138. Communicating fluidly with the vacuum chamber are preferably a plurality of web vacuum holes 158 extending through the web surface 150 and a plurality of support vacuum holes 160 extending through the support surface 152. The web vacuum holes 158 are provided about the first web surface 150, and may be evenly spaced and provided near at least a portion of the perimeter of the web surface 138. The support vacuum holes 160 provide a means for drawing a vacuum through the web vacuum holes 158 and the vacuum chamber in the puck body 138. Preferably, the support vacuum holes 160 are mateable and adapted to cooperate with the vacuum apertures 162 extending into the puck support 154. By imparting a force to the bearing shaft 148 or other portion of the puck 116, the puck 116 may be spun from a web-receiving orientation 164 to a web-placement orientation 166. Such force may be applied to the bearing shaft 148 using any means known in the art including, but not limited to, by way of a spin linkage (not shown) coupled to both the bearing shaft 148 and a spin cam follower (not shown), which is disposed at least partially in a spin cam race (not shown) as is shown and described in detail in U.S. Pat. No. 7,975,584, which is incorporated herein by reference. Though any web placement position 166 angle may be desirable, the depicted angle 168 is ninety degrees from the web receiving position 164.

The puck body 138 preferably includes a first end and a second end. The puck 116 preferably includes a pair of end segments 139, with a first end segment 139 at the first end of the puck body 138 and a second end segment 139 at the second end of the puck body 138. Each end segment 139 has an end web surface 151.

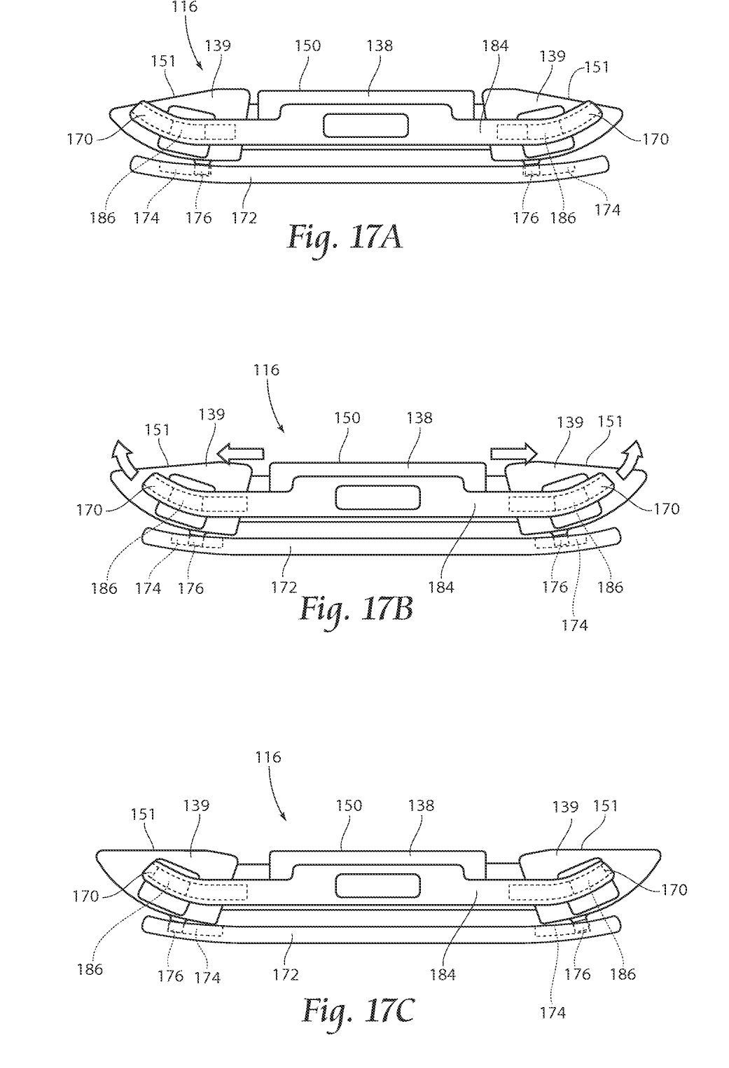

Each end segment 139 is preferably slidably disposed upon a pair of rails 170. In the illustrated embodiment four rail segments 170 are mounted on a pair of rail plates 184. Each end segment 139 has a block 186 sized and configured for slidable engagement with an associated rail 170 disposed on each lateral side thereof. Preferably, the rails 170 are configured to allow the associated end segment 139 to slide away from the puck body 138 while the end segment 139 tilts as shown in FIGS. 17A through 17C. Specifically, each of the rails 170 preferably has a first end adjacent the puck body 138 and an opposed second end. Each of the rails 170 preferably includes a generally horizontal portion at the first end thereof. Each rail 170 is preferably generally curved toward the web surface 150 as shown in FIGS. 17A through 17C. In this manner, as the end segments 139 slide away from the puck body 138 along the rails 170, the angle of the end web surface 151 relative to the web surface 150 is changed. When the end segments 139 are at the position furthest from the puck body 138 the end web surface 151 of each end segment 139 is generally parallel to the web surface 150.

A cam plate 172 is preferably provided between a desired puck support 154 and the puck 116. The cam plate 172 preferably includes at least one cam groove 174 having a changing radius. Thus, when the puck 116 is in the web receiving position 164, the end segments 139 are in a first position, preferably nearer the puck body 138 (see FIG. 17A). When the puck 116 is in the web placement position 166, the end segments are in a second position, preferably further from the puck body 138 (see FIG. 17C).

It should be understood that the foregoing arrangement serves to effect the slide of the end segments 139, in a generally up-and-out manner. As the rotation of the bearing shaft 148 causes the puck 116 to spins from the web receiving position 165 to the web placement position 166, an end web cam follower 176 that is placed in the cam groove 174 causes the end segment 139 to slide along the rails 170 from a first position (see FIG. 17A) to a second position, preferably further from the puck body 138 (see FIG. 17C). The engagement of the block 186 with the rails 170 causes the each end segment 139 to rotate as it slides away from the puck body 138 along the rails.

The end web surfaces 139 are also preferably provided with a plurality of web vacuum holes 158 in fluid communication with an end web vacuum chamber 178. The end web vacuum chamber 178 is preferably in fluid communication with the vacuum chamber (not shown) in the puck body 138. Such fluid communication between the end web vacuum chamber 274 and puck body 138 vacuum chamber may be provided by one or more vacuum bellows 180.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An apparatus for transferring articles from a first conveying device onto a second conveying device comprising a rotating body comprising a plurality of surfaces to present a multi-planar article carrying surface, said multi-planar article carrying surface transforming to a single planar article carrying surface during rotation of said rotating body.
